(19) United States
(12) Patent Application Publication
(10) Pub. No.: US 2016/0099919 A1
(43) Pub. Date: Apr. 7, 2016

(54) SYSTEM AND METHOD FOR PROVIDING A SECURE ONE-TIME USE CAPSULE BASED PERSONALIZED AND ENCRYPTED ON-DEMAND COMMUNICATION PLATFORM

(71) Applicants: Benjamin Daniels, Needham, MA (US); Ramesh Nagappan, Needham, MA (US); Bogdan Vasiliu, Belmont, MA (US)

(72) Inventors: Benjamin Daniels, Needham, MA (US); Ramesh Nagappan, Needham, MA (US); Bogdan Vasiliu, Belmont, MA (US)

(21) Appl. No.: 14/506,574

(22) Filed: Oct. 3, 2014

(51) Int. Cl. H04L 29/06; H04L 12/24; G06F 9/455; H04L 29/08

(52) U.S. Cl. CPC H04L 63/0428; H04L 67/141; H04L 41/0806; G06F 9/45558; G06F 2009/45587; G06F 2009/45595

(57) ABSTRACT

A secure one-time use capsule based personalized and encrypted on-demand communication platform enables encrypted personalized secure on-demand stateless single-use capsuled communication channels over the Internet. Using the personalized capsuled secure communication system, a greater degree of communication security can be achieved than in the existing conventional methods. In one embodiment, the personalized capsuled secure communication system includes a capsule infrastructure system (330) that hosts the personalized secure on-demand stateless single-use capsules; multiple personalized secure on-demand stateless single-use capsule (332) systems for enabling, protecting, and isolating the communication traffic between a call initiator (310) and a call recipient (311); a user defined encrypted communication and data transfer service (334) configured and running inside the capsule; a capsule management server system (336) for managing the life cycle of the personalized secure on-demand stateless single-use capsule and the call initiator's requests for communication; a restricted internal network (331) used by the capsule management server system to manage the personalized secure on-demand stateless single-use capsules; a service initiator client application (314) installed and running on a personal desktop/mobile client device (312) and used by the call initiator for establishing a communication channel with one or more call recipients; a service recipient client application (316) installed and running on a personal desktop/mobile client device (312) and used by the call recipient for establishing a communication channel with the call recipient; one or more encrypted communication channels over the Internet (320) over which the call initiators communicate with the call recipients; multiple subscriber-only secure channels (322) over which the call initiators connect to the capsule infrastructure system and initiate communication calls with the call recipients.

### CROSS-REFERENCE TO RELATED APPLICATIONS

This application claims the benefit of provisional patent application Ser. No. 61/861,996, filed 2013 Aug. 3 by the present inventors.

### BACKGROUND

### Prior Art

The following is a tabulation of some prior art that presently appears relevant:

### U.S. Patents

| Patent Number | Kind Code | Issue Date | Patentee |
|---|---|---|---|
| 7,996,775 | B2 | 2011 Aug. 9 | Cole et al. |
| 8,009,572 | B2 | 2011 Aug. 30 | Heinla et al. |
| 8,111,687 | B2 | 2012 Feb. 7 | Kutt et al. |
| 8,175,091 | B2 | 2012 May 8 | Kaal |
| 8,391,484 | B2 | 2013 Mar. 5 | Kwon et al. |
| 8,489,887 | B1 | 2013 Jul. 16 | Newman et al. |

### U.S. Patent Application Publications

| Publication Nr. | Kind Code | Publ. Date | Applicant |
|---|---|---|---|
| 2010/0177770 | A1 | 2010 Jul. 15 | Heinla et al. |
| 2013/0039226 | A1 | 2013 Feb. 14 | Sridhar |

Today's Internet communication technologies rely on either centralized or peer-to-peer communication architectures in order to establish live connectivity among Internet users. In the centralized communication approach, the communication among users takes place over a central server system that handles all the communication traffic. The central server manages the user accounts, passwords, cryptographic keys, digital certificates, and establishes the communication among users. In the peer-to-peer communication approach individual users communicate directly with each other without the need of a central server, however the user accounts, passwords, cryptographic keys, and digital certificates are still managed by a central server.

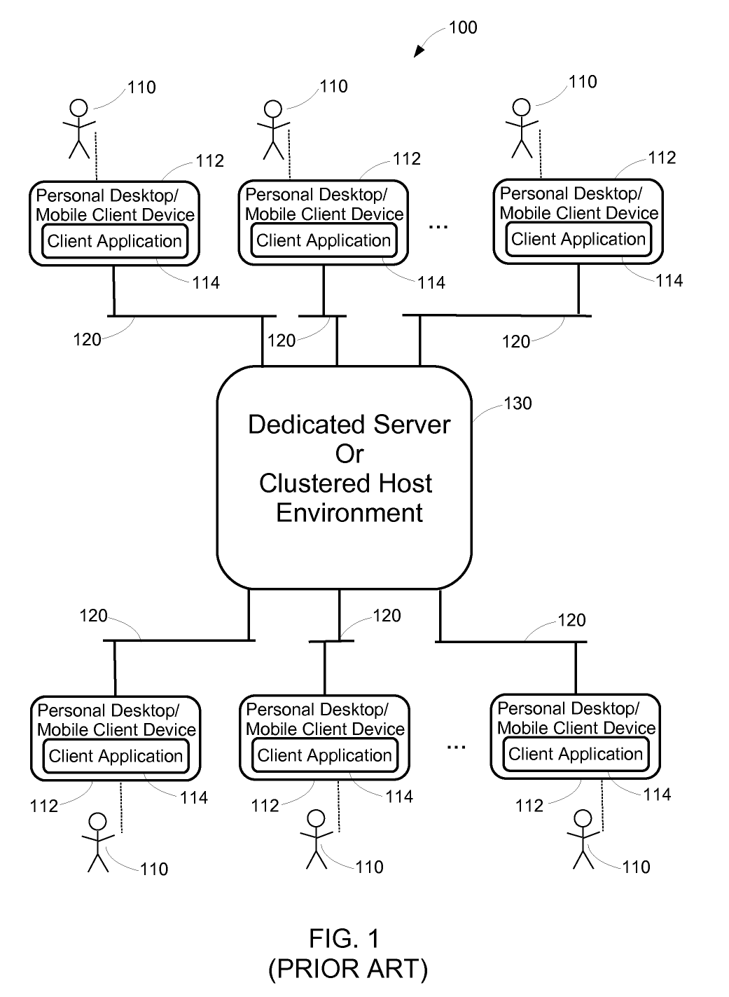

FIG. 1 illustrates an example centralized communication system 100 over the Internet 120 of the prior art. The centralized communication system 100 consists of a Dedicated Server Or Clustered Host Environment 130 and several Desktop/Mobile Client Devices 112 running Client Applications 114 that facilitate the users' 110 communication over the Internet 120 with other user or users 110. The Desktop/Mobile Client Devices 112 communicate using encrypted communication channels over the Internet 120 via the Dedicated Server or Clustered Host Environment 130. The Dedicated Server or Clustered Host Environment 130 is common for all the users 110 involved in the communication and is the central authority that coordinates the authorization, authentication, and communication between the Desktop/Mobile Client Devices 112.

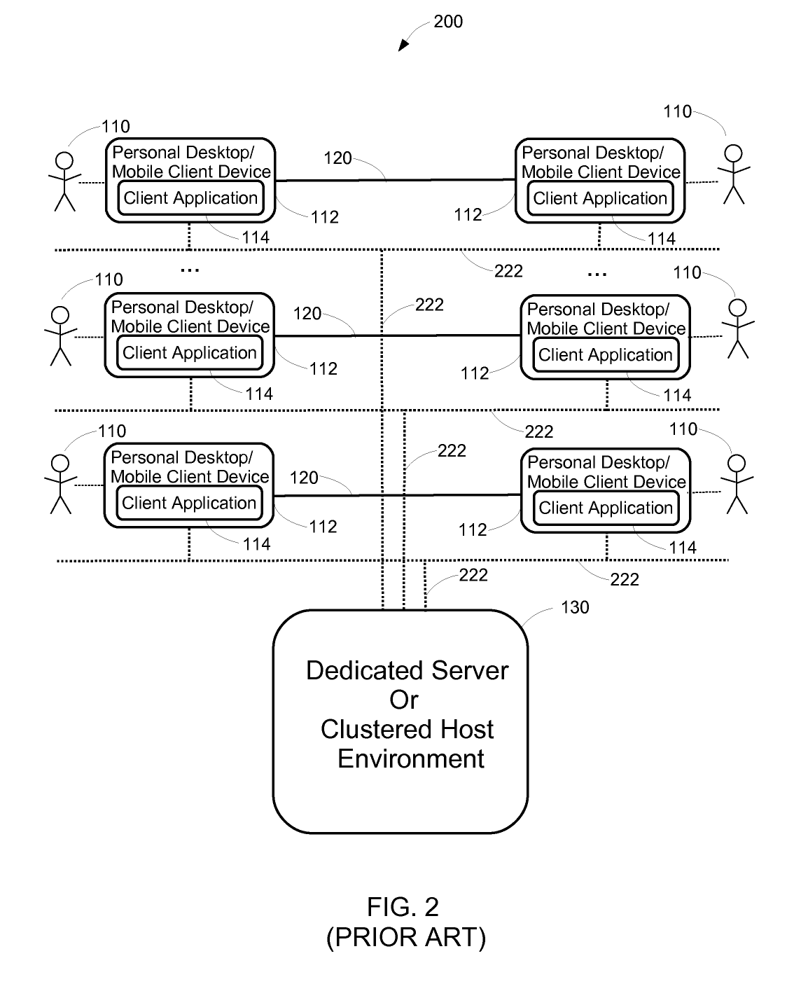

FIG. 2 illustrates an example peer-to-peer communication system 200 over the Internet of the prior art. The peer-to-peer communication system 100 consists of a Dedicated Server Or Clustered Host Environment 130 and several Desktop/Mobile Client Devices 112 running Client Applications 114 that facilitate the user 110 communication over the Internet 120. The Desktop/Mobile Client Devices 112 communicate with each other using encrypted communication channels over the Internet 120, without any intermediary. In this system, the Dedicated Server Or Clustered Host Environment 130 only facilitates the initial communication hand shake (authorization and authentication) via encrypted communication channels 222 and then the Desktop/Mobile Client Applications 102 establish a direct encrypted communication channel over the Internet 120.

The centralized and peer-to-peer communication approaches suffer from a number of disadvantages:
(a) In the centralized communication approach, the communication attributes or its remnant traces can be recorded by running an intermediary application that has the potential for snooping, eavesdropping and man-in-the-middle attacks over the network and the hosting compute environment.
(b) In the centralized communication approach, the communication channels are not isolated from each other as they run on a common shared compute server environment or a pool of compute environments shared by all users.
(c) In the centralized communication approach, the increase in the number of users could pose significant challenges to the scalability of the centralized server system.
(d) In the peer-to-peer communication approach, the peer-to-peer network relies on the individual user devices to route communication traffic among themselves thus allowing for potential outages in circumstances in which not enough user devices are available to route the communication traffic.
(e) In the peer-to-peer communication approach, rogue user devices can be inserted in the peer-to-peer network thus creating the potential for snooping and intercepting user communication.
(f) In either communication approach, a central server holds the communication security keys and digital certificates of the users involved in the communication network thus allowing the communication service provider itself to snoop on the users' communication.
(g) In either communication approach, the registration of the communicating peers with the provider is mandatory for the deployment of the communication. The provider identifies the communicating peers by registering them.
(h) In either communication approach, no out of band communication is possible without the knowledge of the provider.
(i) In either communication approach, the encrypted communication is managed by the provider and the provider has the potential for snooping as the security keys and digital certificates are owned by the provider.
(j) In either communication approach, the communicating peers have no control over the encryption method.
(k) In either communication approach, the communicating peers can be easily identified by the provider, whether they are communicating from a public or private network.
(l) In either communication approach, the provider can log both peers and their originating Internet addresses, time elapsed, and location details.

### SUMMARY

In accordance with one embodiment, a personalized secure on-demand stateless single-use capsule enables secure and private communication over the Internet among multiple participating users. Using the personalized secure on-demand stateless single-use capsule a greater degree of security and privacy for communication over the Internet can be achieved than with the current Internet communication technologies.

In accordance with another embodiment a secure Internet communication system comprises a single or multiple personalized secure on-demand stateless single-use capsule systems for enabling, protecting, and isolating the network communication traffic between a call initiator and one or several call recipients; a user defined communication service installed on the personalized secure on-demand stateless single-use capsule; a server system for managing the life cycle of the personalized secure on-demand stateless single-use capsule.

In another embodiment, a method comprises initiating a call request by a call initiator; processing the call initiator's request; scheduling the activation of a personalized on-demand stateless single-use capsule and encrypted communication channel; notifying one or several call recipients with a one-time use URI, a one-time use login name and password, and a call time and call duration; initiating the secure communication with the call recipient or recipients; terminating the secure communication with the call recipient or recipients.

In yet another embodiment, a method comprises receiving a call request via e-mail, text message, or other secure communication means by a call recipient; retrieving the one-time use URI and login credentials (one-time use login name and password) from the call initiator's message; accessing the retrieved URI and entering the one-time use login name and password; initiating the secure communication with the call initiator; terminating the secure communication with the call initiator.

### Advantages

The personalized secure on-demand stateless single-use capsuled communication allows for a greater degree of privacy and security for communication over the Internet than the currently available solutions provide. The personalized secure on-demand stateless single-use capsule provides a trusted tamper-proof secure communication channel over the Internet that cannot be intercepted or wiretapped or recorded or hijacked by any adversary on the Internet and its operational environment.

Unlike the prior art, the personalized secure on-demand stateless single-use capsule provides a secure communication channel in which only the call initiating party is required to be a subscriber of the secure communication system, while the recipient party does not need to be a subscriber or is not required to have a subscriber account on the secure communication system. This feature is necessary in circumstances in which the recipient party, for whatever reason, cannot or is not allowed or does not need to have a subscriber account on the secure communication system.

Another unique feature of the secure communication system is the isolation of the communication channel from other communication channels, by relying on a personalized on-demand stateless single-use capsule environment that encloses all the software logic required for establishing the secure communication.

The personalized secure on-demand stateless single-use capsule is terminated at the end of the secure communication session with no traces of the communication maintained, the capsule is deleted, and all the communication logs are erased. Any data retention is prevented, no recording of the information can be retrieved later, and no traceable reminiscence or residual information can be collected, thus maintaining communication privacy. Since the capsule is terminated at the end of the communication any attempt to later hack into the capsule to install a virus or trojan horse will be impossible. Newer capsule instances will have different URIs which will make finding and hacking into them even more difficult. The cryptographic keys and digital certificates used in the communication belong to the users involved and are not stored on a central server thus making any attempt to snoop on the conversation virtually impossible. Moreover the communication cryptographic keys and digital certificates are one-time use which renders them useless once the communication session ends.

### DRAWINGS

### Figures

FIG. 1 shows an architecture diagram of a prior art communication system over the Internet via a central server environment.

FIG. 2 shows an architecture diagram of a prior art direct peer-to-peer communication system over the Internet.

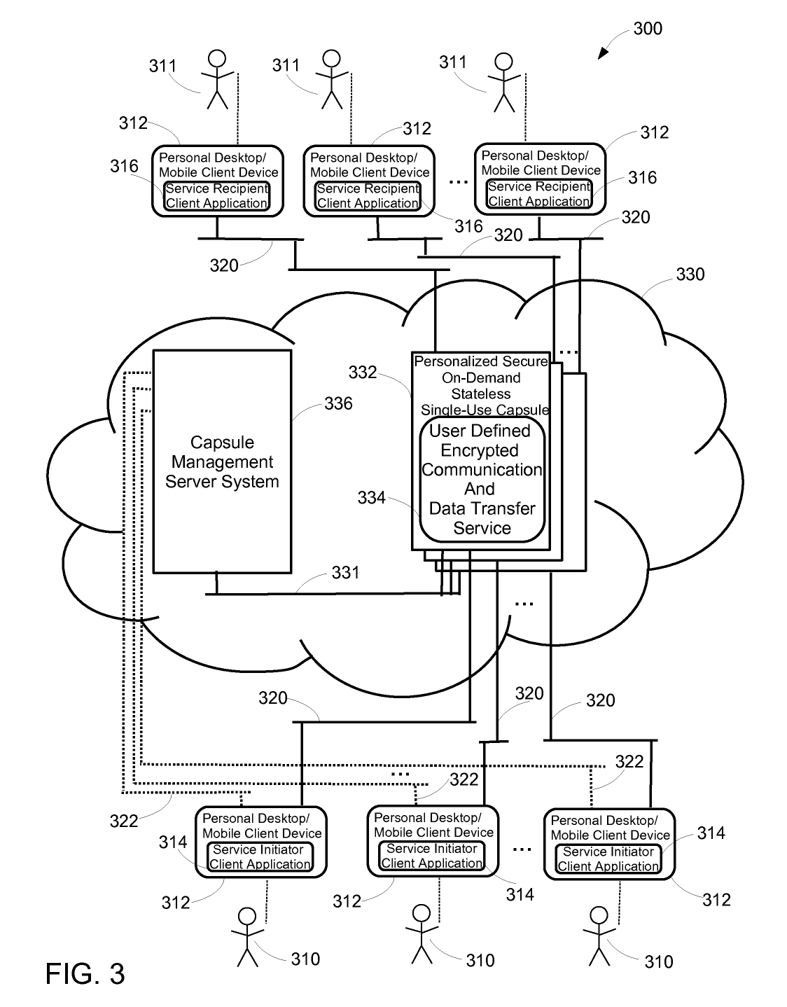

FIG. 3 shows an architecture diagram of a personalized capsuled communication system over the Internet with the capsules managed at a central service provider owned location in accordance with one embodiment.

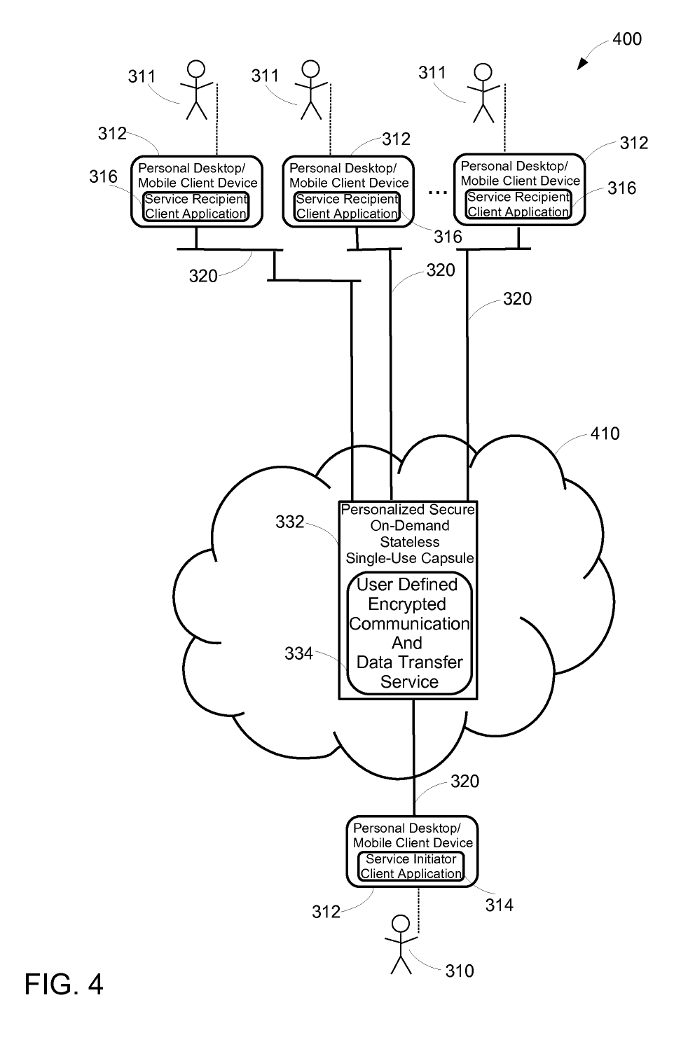

FIG. 4 shows a similar architecture diagram of a personalized capsuled communication system over the Internet with the capsules managed by the call initiator's infrastructure.

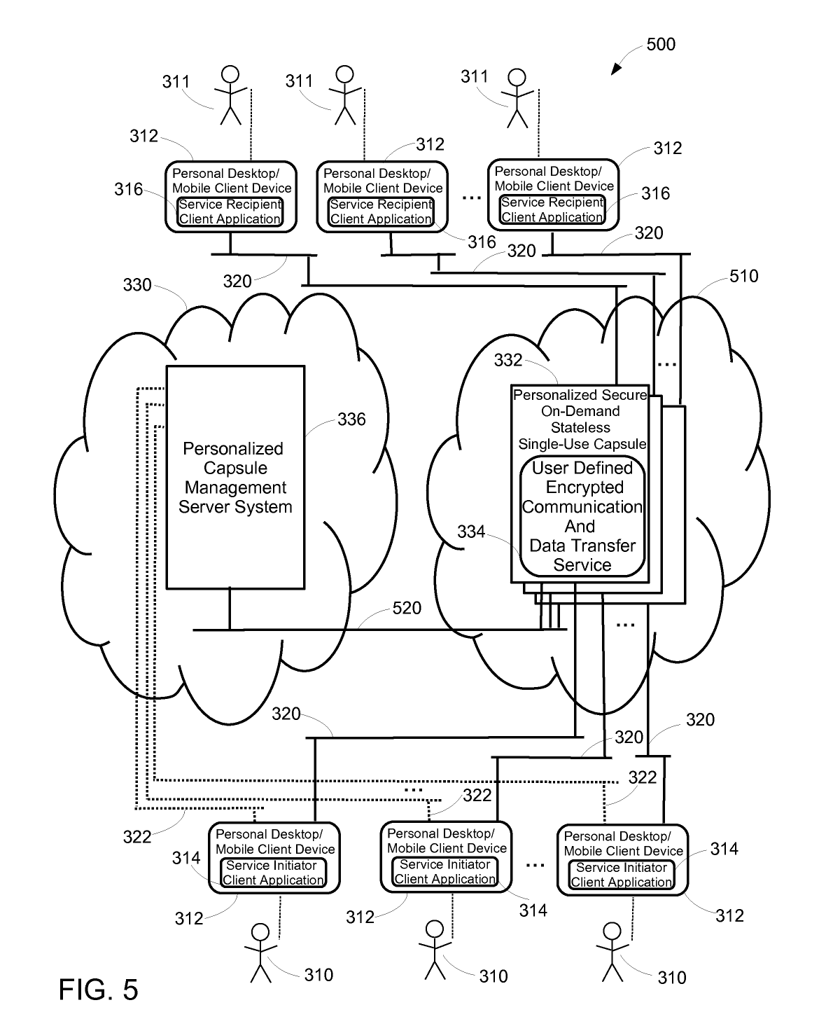

FIG. 5 shows a similar architecture diagram of a personalized capsuled communication system over the Internet with a single capsule scenario, where the single capsule is managed by the call initiator in accordance with another embodiment.

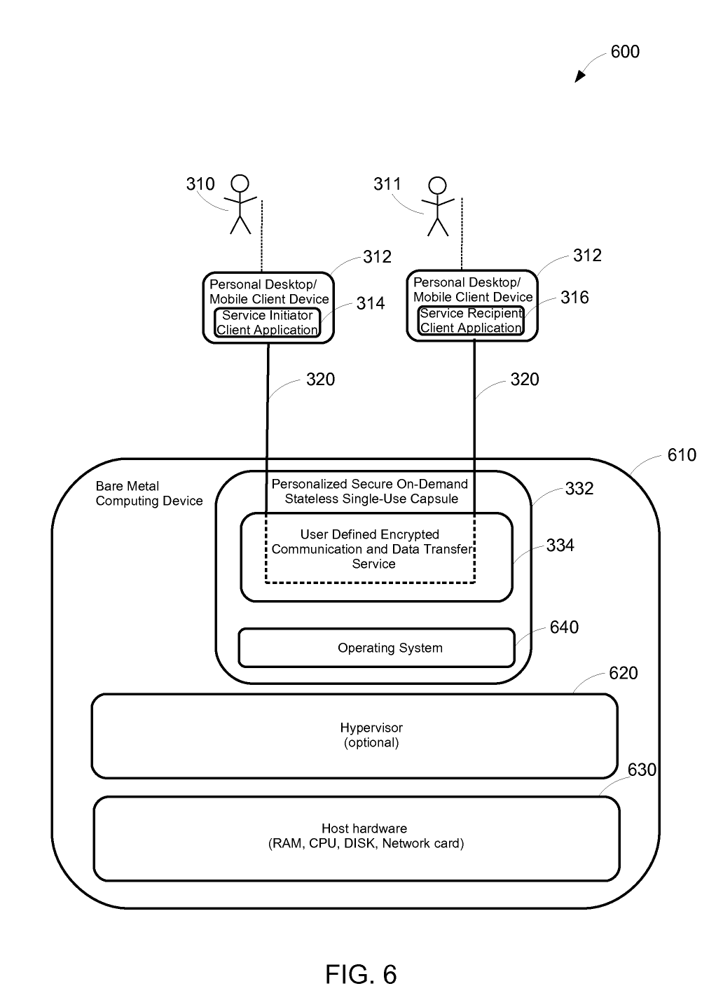

FIG. 6 shows a similar architecture diagram of a personalized capsuled communication system over the Internet with the capsules hosted on a public cloud infrastructure.

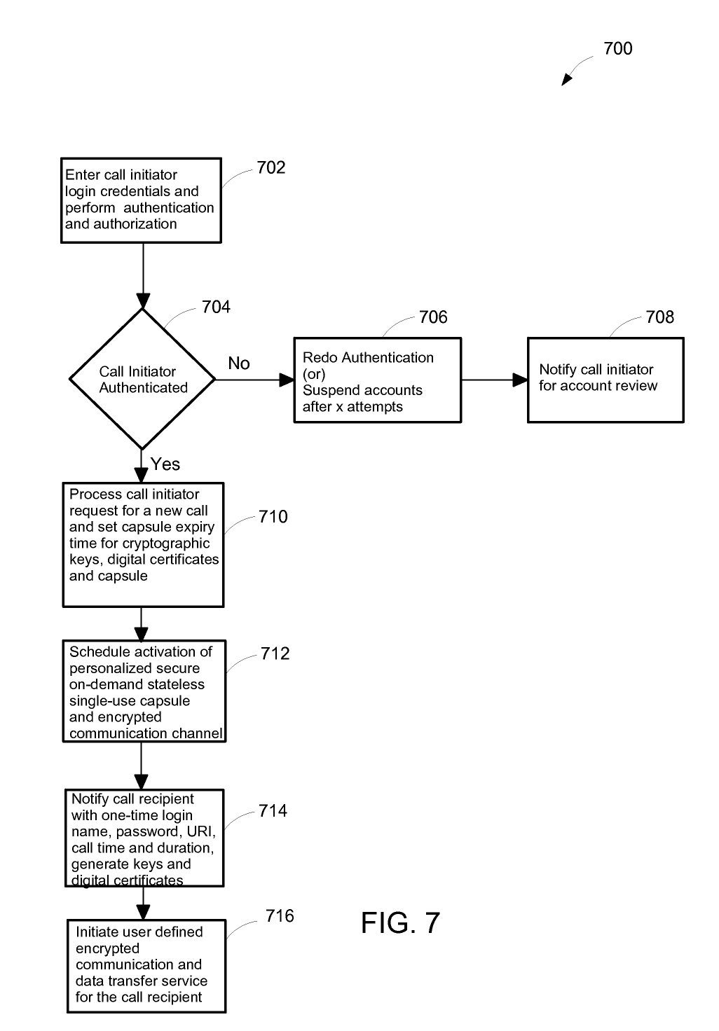

FIG. 7 shows the flowchart representing the process of initiating a trusted personalized capsuled communication channel by a call initiator.

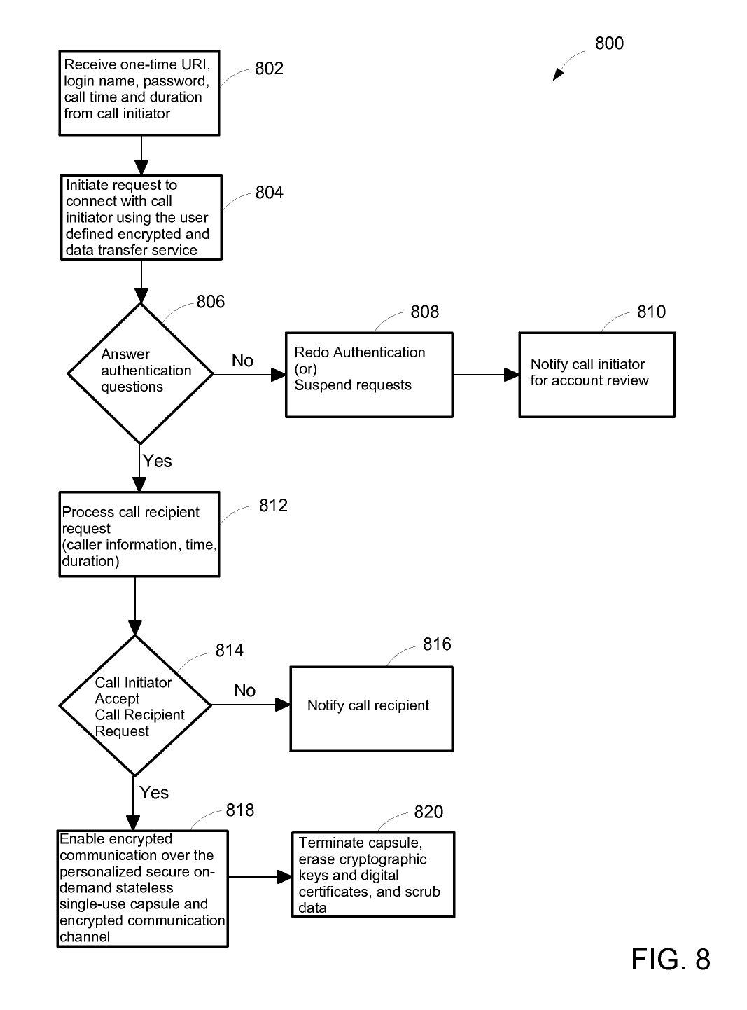

FIG. 8 shows the flowchart representing the process of joining a trusted personalized capsuled communication channel by a call recipient.

### REFERENCE NUMERALS

300 personalized capsuled secure communication system according to one embodiment
310 call initiator
311 call recipient
312 personal desktop/mobile client device
314 service initiator client application
316 service recipient client application
320 encrypted communication channel over the Internet
322 subscriber-only secure channel
330 capsule infrastructure system
331 restricted internal network
332 personalized secure on-demand stateless single-use capsule
334 user defined encrypted communication and data transfer service
336 capsule management server system
400 personalized capsuled communication system according to another embodiment
410 single-capsule infrastructure system
500 personalized capsuled communication system according to another embodiment
510 public cloud
520 encrypted public network channel
600 personalized secure on-demand stateless single-use capsule
610 bare metal computing device
620 hypervisor
630 host hardware (memory, cpu(s), disk(s), network card(s))
640 operating system

### DETAILED DESCRIPTION

### FIGS. 3 and 6—First Embodiment

One embodiment of the personalized capsuled secure communication system 300 is presented in FIG. 3. In the personalized capsuled secure communication system 300 each call initiator 310 communicates live with one or multiple call recipients 311 via the personalized secure on-demand stateless single-use capsule 332 hosted in the capsule infrastructure system 330.

The capsule infrastructure system 330 is the overall operational infrastructure that hosts the computing environment (hardware and software) that enables the secure communication session, made available over the Internet.

The call initiator 310 is the human subscriber who owns a legitimate account on the capsule infrastructure system 330. The call initiator 310 has the privileges to schedule, initiate, and terminate a communication session with a call recipient 311. In order to initiate and participate in a communication session, the call initiator 310 uses the service initiator client application 314 installed on the personal desktop/mobile client device 312.

The call recipient 311 is the on-demand human participant who joins in the communication session initiated by the call initiator 310. The call recipient 311 will be assigned with a one-time use login name and password, and a one-time use URI to access the dedicated encrypted communication channel over the Internet 320 initiated by the call initiator 310. The call recipient 311 uses the service recipient client application 316 to join in the requested communication session. The call recipient 311 is not a subscriber on the capsule infrastructure system 330 and does not have an account on this system.

The service initiator client application 314 and the service recipient client application 316 are specialized client applications capable of performing audio, video, data communications, and other user defined communications over the Internet. Both applications execute on a desktop computer, laptop, tablet, smart phone, mobile phone, or any other electronic device that is equipped with a video camera, speaker(s), microphone, display/screen/monitor and keyboard and is connected to the Internet either wired or wirelessly and is capable of sending and receiving data on the Internet.

The encrypted communication channel over the Internet 320 is a dedicated tamper-proof encrypted communication channel over the Internet, over which all the communication takes place.

The call initiator 310 uses the service initiator client application 314 installed on the personal desktop/mobile client device 312 to establish a live communication session with the call recipient 311. Similarly, the call recipient 311 uses the service recipient client application 316 installed on the personal desktop/mobile client device 312 to establish the live communication with the call initiator 310.

The service initiator client application 314 and the service recipient client application 316 connect to the personalized secure on-demand stateless single-use capsule 332 via encrypted communication channels over the Internet 320. The personalized secure on-demand stateless single-use capsule 332 is installed, configured, and it is executing inside the capsule infrastructure system 330. The capsule infrastructure system 330 creates the personalized secure on-demand stateless single-use capsule 332 when the communication between a call initiator 310 and one or more call recipient(s) 311 starts, and it destroys it when the communication ends. No communication trace, recording, or log file is preserved after the communication ends. The personalized secure on-demand stateless single-use capsule 332 is dedicated to only one communication session between a call initiator 310 and one or more call recipient(s) 311 that received a call invitation from said call initiator 310, and no other users are allowed access to it during the communication session.

The capsule infrastructure system 330 consists of a capsule management server system 336 and multiple personalized secure on-demand stateless single-use capsules 332. The management server system 336 controls the life cycle of the personalized secure on-demand stateless single-use capsules 332 via the restricted internal network 331. The management server system 336 receives requests for new personalized secure on-demand stateless single-use capsules 332 from the call initiators 310 via the subscriber-only secure channels 322. The subscriber-only secure channels 322 are dedicated encrypted communication channels over the Internet for subscription and self-service functions available to call initiator 310 accounts.

The management server system 336 comprises the software components intended for managing the user accounts (call initiators 310), enforcing password based authentication, managing the schedule of calls, and managing the lifecycle of the personalized secure on-demand stateless single-use capsule 332.

The restricted internal network 331 is an internal administrative network accessible to the security and system administrator of the capsule management system 336. Both the management server system 336 and the personalized secure on-demand stateless single-use capsule 332 are hosted on this network.

FIG. 6 describes the personalized secure on-demand stateless single-use capsule 332. The personalized secure on-demand stateless single-use capsule 332 is accessible via an encrypted communication channel over the Internet 320 where the one-time encryption is provided by the call initiator 310. The personalized secure on-demand stateless single-use capsule 332 comprises an operating system 640 instance running on a hypervisor 620 or directly on a host hardware 630 of a bare metal computing device 610 such as a compute server or a personal computer, and a user defined encrypted communication and data transfer service 334. The operating system contains intrusion prevention and detection capabilities (not pictured here) in order to ensure confidentiality and integrity of the communication. The user defined encrypted communication and data transfer service 334 is a software environment comprising software components that facilitate secure audio, video, data or other user defined communication between a call initiator 310 and one or multiple call recipients 311. The personalized secure on-demand stateless single-use capsule 332 will be activated for use only after mutual authentication between the call initiator 310 and the call recipient 311 is completed. At the end of the call, the personalized secure on-demand stateless single-use capsule 332 will be terminated and deleted without collecting any remnant data.

### Operation—FIGS. 7, 8

FIG. 7 is the flowchart presenting the Call Initiator Workflow 700 that describes the step-by-step process of initiating a trusted communication channel by a call initiator 310. At step 702 the call initiator 310 starts the authentication and authorization process that would allow him or her to initiate a secure communication session. Via the service initiator client application 314 and over the subscriber-only channel 322, the call initiator 310 accesses the capsule management system 336 where they enter their authorization and authentication credentials. These authorization and authentication credentials are processed at step 704. If the authorization and authentication credentials are incorrect then, at step 706, the call initiator 310 is prompted to repeat the process for a limited number of attempts. If the call initiator's 310 authorization and authentication process fails past the allowed number of attempts then the account owner is notified at step 708. If the call initiator 310 authorization and authentication process is successful, then at step 710 the call initiator 310 is allowed to create and schedule a secure communication call session: the call initiator 310 will input the call recipient's 311 information (e-mail address, and/or mobile phone number, or other means for uniquely identifying them), time and duration of the call, and create the cryptographic keys and digital certificates, set the encryption algorithms and the personalized secure on-demand stateless single-use capsule's 332 expiry time. At step 712 the activation of the personalized secure on-demand stateless single-use capsule 332 is scheduled; the personalized secure on-demand stateless single-use capsule 332 may be activated instantaneously or at a certain time in the future depending on the choices made by the call initiator 310. At step 714 the call recipient 311 is notified with the one-time use URI, one-time use login name and password, and the time and duration of the call. At step 716 the user defined encrypted communication and data transfer service 334 is initiated so that the call recipient 311 can connect to it and participate in the call session.

FIG. 8 is the flowchart presenting the Call Recipient Workflow 800 that describes the step-by-step process of joining a trusted communication channel by a call recipient 311. At step 802 the call recipient 311 receives, via an e-mail message, text message, or some other communication means, a one-time use URI, one-time use login name and password, the time for joining the call, and the duration of the call. At step 804 the call recipient 311 uses the service recipient client application 316 to initiate the request to connect with the call initiator 310 using the user defined encrypted communication and data transfer service 334. This step includes starting the service recipient client application 316 and entering the one-time use URI, the one-time use login name and password. At step 806, if the call recipient 311 enters incorrect information, he or she is prompted to re-enter this information at step 808. Step 808 can be repeated a limited number of times after which, if the attempts are still unsuccessful, the request to join the call is suspended and at step 810 the call initiator 310 is notified for review. If step 806 is successful then the call initiator 310 is notified in order to accept the call or not. If the call initiator 310 chooses to reject the call then, at step 816, the call recipient 311 is informed about this decision and the communication attempt is terminated. If the call initiator 310 accepts the call recipient 311 then at step 818 the personalized secure on-demand stateless single-use capsule 332 is started and the encrypted communication channel over the Internet 320 is opened. Once the communication session ends, at step 820, the personalized secure on-demand stateless single-use capsule 332 is terminated and deleted, the encryptions keys and digital certificates and all the communication data is erased, and the encrypted communication channel over the Internet 320 is closed.

### FIG. 4

### Additional Embodiment

An additional embodiment is shown in FIG. 4. In this embodiment, the call initiator 310 owns and manages a single personalized secure on-demand stateless single-use capsule 332 in their own single-capsule infrastructure system 410. A limited capsule management server system (not pictured here) is also installed locally to manage the life cycle of the personalized secure on-demand stateless single-use capsule 332.

### FIG. 5

### Additional Embodiments

An additional embodiment is shown in FIG. 5. In this embodiment, some or all of the personalized secure on-demand stateless single-use capsules 332 are hosted remotely, on different premises than the capsule management system 336, such as on a public cloud 510. The capsule management system 336 manages the remote capsules via the encrypted public network channel 520.

### Advantages

The embodiments described above present a number of advantages:
(a) The capsule based communication isolates the users' communication channels from each other thus providing a tamper-proof communication environment on the Internet without requiring the use of any provider resources.
(b) Only the subscriber can identify the intended recipient of the communication. The service provider will not be able to track or monitor the communicating peers, their messages, and time of communication.
(c) No centralized communication provider required.
(d) No dependency on other intermediate hosting peers or lookup services like in the case of peer-to-peer and centralized communication approaches.
(e) User defined encryption facilitates full control of the encryption of communication and data transfer by the subscriber. The subscriber defines the encryption with required cryptographic material during the communication. No reuse of cryptographic material as the exchanged cryptographic keys, digital certificates and encrypted content will be automatically erased after use right after the subscriber terminates the communication.
(f) The user defined communication and data transfer include audio, video, data or a combination of other user defined communication such as web services, chat, etc. The subscriber can define their own communication means.
(g) The fully personalized capsule is defined by the subscriber before use. The subscriber chooses the capsule environment and its characteristics including its security and privacy requirements.
(h) One time use capsule: the URI of the capsule changes with each communication session, thus minimizing the possibility of hacking into the capsule and installing trojan horses, key loggers, viruses, or other snooping software. The capsule is terminated and deleted at the end of the communication and it is never reused so it is impossible to hack into it later.
(i) On-Demand capsule: the capsule is created at the beginning of the communication session; this prevents it from unnecessarily using compute resource or being hacked into it before the communication session begins.
(j) The communication is tamper proof and immune to eavesdropping since the subscriber owns the communication channel, the cryptographic keys, and the digital certificates.
(k) The capsule is terminated at the end of the communication, thus no processes are left running behind, which would allow an attacker to possibly collect remnant communication data.
(l) Stateless capsule: the capsuled communication is not recorded, no data or log files are left after the capsule is terminated, thus ensuring full communication privacy.
(m) The capsule owner owns the cryptographic keys and digital certificates which are for one-time use only, the cryptographic keys and the digital certificates are never reused.
(n) The capsule can run on public, private, hybrid clouds, local user owned environments such as hypervisors, or capsule management infrastructures owned by the system's proprietors.
(o) Only the call initiator is a subscriber on the system, the call recipient is not a subscriber; this broadens the scope of the communication since participants are not required to be subscribers of the communication system.
(p) No scalability or resource issues since the capsule can run anywhere; no outages as in peer-to-peer communications where outages in the peer nodes could cause communication break downs.

### CONCLUSION, RAMIFICATIONS, AND SCOPE

The Capsule Based Personalized and Encrypted On-Demand Communication Platform allows a call initiator user to place secure communication calls to other users without worrying about these calls being intercepted and recorded by a third party. The call recipient users do not need to be subscribers of the communication platform thus allowing significant more flexibility in establishing communication over the Internet and in providing private and secure communication channels. The call initiator user can choose their own encryption method, cryptographic keys, digital certificates, and communication method (audio/video, text, data, web services, etc.) without any limitations imposed by a service provider. Only the call initiator and the call recipients know the time of the call, and the location (URI) of the communication capsule. This prevents third party snoopers from knowing in advance the details of the communication session and attempt to prepare means that would allow them to snoop on the communication.

The call initiator user can own the secure capsule and manage it independently of a service provider, or they can host the secure capsule in a cloud (public, private, or hybrid) and in this way further protect it from possible tampering. Since the communication capsule is one-time use, and the communication cryptographic keys and digital certificates are also one-time use, and no communication traces are preserved from one communication session to another, any attempts to tamper or hijack the communication capsule are virtually impossible.

The foregoing description contains many details that should not limit the scope of the invention, but merely constitute illustrations of some of several embodiments. The scope of the invention should therefore not be limited by the above described embodiments, methods, and examples, but by the appended claims. The appended claims and their legal equivalents cover all the features and advantages of the invention that fall within the true scope and spirit of the invention.

We claim:

1. A capsuled communication system, comprising:
(a) a multitude of personalized secure on-demand stateless single-use capsule systems for facilitating, enabling, protecting, and isolating communication calls between call initiators and call recipients, where each said personalized secure on-demand stateless single-use capsule system enables communication between one said call initiator and one or more said call recipients;
(b) said personalized secure on-demand stateless single-use capsule system comprising a user defined encrypted communication and data transfer service configured and executing inside said personalized secure on-demand stateless single-use capsule system for facilitating secure audio, video, data, and other user defined communication between said call initiators and said call recipients;
(c) said personalized secure on-demand stateless single-use capsule system including an operating system and intrusion prevention and detection capabilities in order to ensure confidentiality and integrity of the communication between said call initiators and said call recipients;
(d) said personalized secure on-demand stateless single-use capsule system that is on-demand, it is started at the beginning of the communication session and it is terminated and deleted at the completion of the communication session;
(e) said call initiators that are the only subscribers to the capsuled communication system, said call recipients are not subscribers to the capsuled communication system;
(f) said personalized secure on-demand stateless single-use capsule system that is stateless and one-time use, it is reachable via a one-time use URI and it is terminated and deleted at the end of the communication, no communication processes are left running behind, the communication is not recorded, and all the communication data is erased with no traces left behind;
(g) user-defined encryption, said call initiator chooses the encryption algorithm, and creates the cryptographic keys and digital certificates necessary for encrypting the communication;
(h) said cryptographic keys and digital certificates that are one-time use, they are erased at the end of the communication session and are never reused;
(i) a capsule management server system for managing the accounts of said call initiators, enforcing secure authentication and authorization of said call initiators, and managing the life cycle of said personalized secure on-demand stateless single-use capsule systems;
(j) a private internal network for managing said personalized secure on-demand stateless single-use capsule systems by said capsule management server system;
(k) a multitude of personal desktop/mobile client devices, each hosting a service initiator client application used to facilitate the communication between said call initiators and said call recipients via said personalized secure on-demand stateless single-use capsule systems;
(l) a multitude of personal desktop/mobile client devices, each hosting a service recipient client application used to facilitate the communication between said call initiators and said call recipients via said personalized secure on-demand stateless single-use capsule systems;

2. The capsuled communication system of claim 1, wherein said personalized on-demand stateless single-use capsule systems are installed, configured, and execute inside virtual environments controlled by hypervisors;

3. The capsule communication system of claim 1, wherein said personalized on-demand stateless single-use capsule systems are installed, configured, and execute directly on bare metal compute servers, or other electronic devices capable of hosting it and running it.

4. The capsuled communication system of claim 1, wherein said personalized on-demand stateless single-use capsule systems are hosted on public, private, or hybrid clouds.

5. In a capsuled communication system, a method for establishing a communication call, comprising:
(a) enabling and facilitating communication calls over a capsuled communication system that comprises:
a multitude of personalized secure on-demand stateless single-use capsule systems for facilitating, enabling, protecting, and isolating communication calls between call initiators and call recipients, where each said personalized secure on-demand stateless single-use capsule system enables communication between one said call initiator and one or more said call recipients;
the personalized secure on-demand stateless single-use capsule system comprising a user defined encrypted communication and data transfer service configured and executing inside said personalized secure on-demand stateless single-use capsule system for facilitating secure audio, video, data, and other user defined communication between said call initiators and said call recipients;
the personalized secure on-demand stateless single-use capsule system including an operating system and intrusion prevention and detection capabilities in order to ensure confidentiality and integrity of the communication between said call initiators and said call recipients;
said personalized secure on-demand stateless single-use capsule system that is on-demand, it is started at the beginning of the communication session and it is terminated and deleted at the completion of the communication session;
said call initiators that are the only subscribers to the capsuled communication system, said call recipients are not subscribers to the capsuled communication system;
said personalized secure on-demand stateless single-use capsule system that is stateless and one-time use, it is reachable via a one-time use URI and it is terminated and deleted at the end of the communication, no communication processes are left running behind, the communication is not recorded, and all the communication data is erased with no traces left behind;
user-defined encryption, said call initiator chooses the encryption algorithm, and creates the cryptographic keys and digital certificates necessary for encrypting the communication;
said cryptographic keys and digital certificates that are one-time use, they are erased at the end of the communication session and are never reused;
a capsule management server system for managing the accounts of said call initiators, enforcing secure authentication and authorization of said call initiators, and managing the life cycle of said personalized secure on-demand stateless single-use capsule systems;
a private internal network for managing of said personalized secure on-demand stateless single-use capsule systems by said capsule management system;
a multitude of personal desktop/mobile client devices, each hosting a service initiator client application used to facilitate the communication between said call initiators and said call recipients via said personalized secure on-demand stateless single-use capsule systems;
a multitude of personal desktop/mobile client devices, each hosting a service recipient client application used to facilitate the communication between said call initiators and said call recipients via said personalized secure on-demand stateless single-use capsule systems;
(b) requesting said call initiators' login credentials;
(c) performing said call initiators' authentication;
(d) processing said call initiators' requests for new communication calls by requesting the calls' details: call recipients' information, call time and duration;
(e) scheduling the activation of said personalized on-demand stateless single-use capsule and said user defined encrypted communication and data transfer service inside said capsule;
(f) generating the one-time use cryptographic keys and digital certificates for encrypting the communication between said call initiator and said call recipients;
(g) setting the expiry time of said personalized on-demand stateless single-use capsule and said cryptographic keys and said digital certificates;
(h) sending the connection credentials, one-time use URI, and one-time use login name and password, to said call recipients;
(i) upon the completion of the communication call, terminating said personalized on-demand stateless single-use capsule, terminating all the communication processes, and erasing said cryptographic keys and said digital certificates, and deleting all the communication data;
(j) receiving a one-time use URI and one-time use login name and password credentials by said call recipients from said call initiators.
(k) connecting by said call recipients to said on-demand stateless single-use capsule by using the one-time use URI, login name and password, received from said call initiators.
(l) activating said personalized secure on-demand stateless single-use capsule and said encrypted communication and data transfer service.
(m) enabling the communication between said call initiators and said call recipients over said personalized secure on-demand stateless single-use capsule and said encrypted communication and data transfer service.

6. The method of claim 5, wherein said personalized on-demand stateless single-use capsule systems are installed, configured, and execute inside virtual environments controlled by hypervisors.

7. The method of claim 5, wherein said personalized on-demand stateless single-use capsule systems are installed, configured, and execute directly on bare metal compute servers, or other electronic devices capable of hosting it and running it.

8. The method of claim 5, wherein said personalized on-demand stateless single-use capsule systems are hosted on public, private, or hybrid clouds.

9. A capsuled communication system, comprising:
(a) a single personalized secure on-demand stateless single-use capsule system for facilitating, enabling, protecting, and isolating communication calls between a call initiator and one or more call recipients;
(b) said personalized secure on-demand stateless single-use capsule being owned and managed by said call initiator without any involvement from a third party remote management server;
(c) said personalized secure on-demand stateless single-use capsule system comprising a user defined encrypted communication and data transfer service configured and executing inside said personalized secure on-demand stateless single-use capsule system for facilitating secure audio, video, data, and other user defined communication between said call initiator and one or more said call recipients;
(d) said personalized secure on-demand stateless single-use capsule system including an operating system and intrusion prevention and detection capabilities in order to ensure confidentiality and integrity of the communication between said call initiator and said call recipients;
(e) said personalized secure on-demand stateless single-use capsule system that is on-demand, it is started at the beginning of the communication session and it is terminated and deleted at the completion of the communication session;
(f) said call initiator that is the only subscriber to the capsuled communication system, said call recipients are not subscribers to the capsuled communication system;
(g) said personalized secure on-demand stateless single-use capsule system that is stateless and one-time use, it is reachable via a one-time use URI and it is terminated and deleted at the end of the communication, no communication processes are left running behind, the communication is not recorded, and all the communication data is erased with no traces left behind;
(h) user-defined encryption, said call initiator chooses the encryption algorithm, and creates the cryptographic keys and digital certificates necessary for encrypting the communication;
(i) said cryptographic keys and digital certificates that are one-time use, they are erased at the end of the communication session and are never reused;
(j) a capsule management server system belonging to said call initiator, for managing the life cycle of said personalized secure on-demand stateless single-use capsule systems;
(k) a private internal network for managing of said personalized secure on-demand stateless single-use capsule system by said capsule management system;
(l) a personal desktop/mobile client device, hosting a service initiator client application used to facilitate the communication between said call initiator and said call recipients via said personalized secure on-demand stateless single-use capsule systems;
(m) a multitude of personal desktop/mobile client devices, each hosting a service recipient client application used to facilitate the communication between said call initiator and said call recipients via said personalized secure on-demand stateless single-use capsule systems;

10. The capsuled communication system of claim 9, wherein said personalized on-demand stateless single-use capsule system runs inside virtual environment controlled by hypervisors;

11. The capsule communication system of claim 9, wherein said personalized on-demand stateless single-use capsule system runs directly on a bare metal compute server, or other electronic device capable of hosting it and running it.

12. The capsuled communication system of claim 9, wherein said personalized on-demand stateless single-use capsule system is hosted on either a public, private, or hybrid cloud.

13. In a capsuled communication system, a method for establishing a communication call, comprising:
(a) enabling and facilitating communication calls over a capsuled communication system that comprises:
a single personalized secure on-demand stateless single-use capsule system for facilitating, enabling, protecting, and isolating communication calls between a call initiator and one or more call recipients;
said personalized secure on-demand stateless single-use capsule being owned and managed by said call initiator without any involvement from a third party remote management server;
said personalized secure on-demand stateless single-use capsule system comprising a user defined encrypted communication and data transfer service configured and executing inside said personalized secure on-demand stateless single-use capsule system for facilitating secure audio, video, data, and other user defined communication between said call initiator and one or more said call recipients;
said personalized secure on-demand stateless single-use capsule system including an operating system and intrusion prevention and detection capabilities in order to ensure confidentiality and integrity of the communication between said call initiators and said call recipients;
said personalized secure on-demand stateless single-use capsule system that is on-demand, it is started at the beginning of the communication session and it is terminated and deleted at the completion of the communication session;
said call initiator that is the only subscriber to the capsuled communication system, said call recipients are not subscribers to the capsuled communication system;
said personalized secure on-demand stateless single-use capsule system that is stateless and one-time use, it is reachable via a one-time use URI and it is terminated and deleted at the end of the communication, no communication processes are left running behind, the communication is not recorded, and all the communication data is erased with no traces left behind;
user-defined encryption, said call initiator chooses the encryption algorithm, and creates the cryptographic keys and digital certificates necessary for encrypting the communication;
said cryptographic keys and digital certificates that are one-time use, they are erased at the end of the communication session and are never reused;
a capsule management server system belonging to said call initiator, for managing the life cycle of said personalized secure on-demand stateless single-use capsule system;
a private internal network for managing said personalized secure on-demand stateless single-use capsule system by said capsule management system;
a personal desktop/mobile client device, hosting a service initiator client application used to facilitate the communication between said call initiator and said call recipients via said personalized secure on-demand stateless single-use capsule systems;
a multitude of personal desktop/mobile client devices, each hosting a service recipient client application used to facilitate the communication between said call initiator and said call recipients via said personalized secure on-demand stateless single-use capsule systems;
(b) requesting said call initiator's login credentials;
(c) performing said call initiator's authentication;
(d) processing said call initiator's requests for new communication calls by requesting the calls' details: each call recipient's information, call time and duration;
(e) scheduling the activation of said personalized on-demand stateless single-use capsule and said user defined encrypted communication and data transfer service inside said capsule;
(f) generating one-time use cryptographic keys and digital certificates for encrypting the communication between said call initiator and said call recipients;
(g) setting the expiry time of said personalized on-demand stateless single-use capsule and cryptographic keys and digital certificates;
(h) sending the connection credentials, one-time use URI, and one-time use login name and password, to said call recipients;
(i) upon the completion of the communication call, terminating said personalized on-demand stateless single-use capsule, terminating all the communication processes, and erasing said cryptographic keys and said digital certificates, and deleting all the communication data;
(j) receiving a one-time use URI and login name and password credentials by said call recipients from said call initiator.
(k) connecting by said call recipient to said on-demand stateless single-use capsule by using the one-time use URI, login name and password, received from said call initiator.
(l) activating said personalized secure on-demand stateless single-use capsule and said encrypted communication channel.
(m) enabling the communication between said call initiator and said call recipients over said personalized secure on-demand stateless single-use capsule and said encrypted communication and data transfer service.

14. The method of claim 13, wherein said personalized on-demand stateless single-use capsule system is installed, configured, and executes inside virtual environments controlled by hypervisors;

15. The method of claim 13, wherein said personalized on-demand stateless single-use capsule system is installed, configured, and executes directly on bare metal compute servers, or other electronic devices capable of hosting it and running it.

16. The method of claim 13, wherein said personalized on-demand stateless single-use capsule system is hosted on either public, private, or hybrid clouds.
